(19) United States
(12) Patent Application Publication
(10) Pub. No.: US 2011/0163118 A1
(43) Pub. Date: Jul. 7, 2011

(54) Metered Dispenser

(75) Inventors: Christopher Gieda, Long Valley, NJ (US); David Honan, Concord, MA (US); Nathan Rollins, Boylston, MA (US); Shane Yellin, Dover, MA (US); Andrew Simon, Worcester, MA (US)

(73) Assignee: UNION STREET BRAND PACKAGING LLC, Northborough, MA (US)

(21) Appl. No.: 12/985,619

(22) Filed: Jan. 6, 2011

Related U.S. Application Data
(60) Provisional application No. 61/292,621, filed on Jan. 6, 2010.

(51) Int. Cl. G01F 11/26

(52) U.S. Cl. 222/1; 222/454; 222/456; 222/452

(57) ABSTRACT

A dispensing apparatus includes a container having an opening, and a doser coupled with the container about the container opening. The doser includes a housing forming a chamber with an interior wall, an inlet, and an outlet. The inlet is diametrically offset from the outlet, and substantially aligned with the opening of the container. The doser also includes a covering member to alternatively cover and open the inlet and the outlet. The covering member is movable about a range of positions to substantially completely cover at least one of the inlet and outlet at all positions in the range. The covering member covers no more than a portion of the chamber interior wall when the covering member completely opens the outlet.

### PRIORITY

This patent application claims priority from provisional U.S. patent application No. 61/292,621, filed Jan. 6, 2010, entitled, “METERED DISPENSER,” and naming Christopher Gieda, David Honan, Nathan Rollins, Shane Yellin, and Andrew Simon as inventors, the disclosure of which is incorporated herein, in its entirety, by reference.

### TECHNICAL FIELD

The invention generally relates to product dispensers, and more particularly the invention relates to metered dispensers.

### BACKGROUND ART

Dispensing containers are widely used to dispense a variety of products, such as granular material (e.g., fiber supplements). To dispense granular material from one widely used dispensing container, a user must remove a cap from its container, pour the material from the container into the cap, and then pour the material into a beverage, such as orange juice or water. The user then screws the cap back onto the container. Other dispensers require a scoop to remove a measured amount of material from the container.

Undesirably, these and other prior art devices and methods often are prone to spillage and waste. In fact, these dispensers also expose the interior of the container to the outside environment, exposing the material to moisture, which can cause the material in the container to form clumps.

### SUMMARY OF THE INVENTION

In accordance with a first embodiment of the invention, a dispensing apparatus includes a container having an opening, and a doser coupled with the container about the container opening. The doser includes a housing forming a chamber with an interior wall, an inlet, and an outlet. The inlet is diametrically offset from the outlet, and substantially aligned with the opening of the container. The doser also includes a covering member to alternatively cover and open the inlet and the outlet. The covering member is movable about a range of positions to substantially completely cover at least one of the inlet and outlet at all positions in the range. The covering member covers no more than a portion of the chamber interior wall when the covering member completely opens the outlet.

In alternative embodiments, the covering member may cover no more than a portion of the chamber interior wall when the inlet is completely open. The doser may be configured so that no part of the inlet is diametrically aligned to any part of the outlet. The covering member may rotate about an axis having two ends according to the motion of a handle coupled to both ends of the axis. The handle may rotate no farther than any portion of an outer periphery of a spout of the dispenser. Accordingly, the handle may be configured not to extend above any portion of the spout. The apparatus also may include a stop removably coupled with the handle and preventing rotation of the handle when coupled with the handle.

A range of positions of the covering member may substantially prevent communication between the interior of the container and the exterior of the dispensing apparatus. The covering member may be a single integral member and may permit material to directly contact the interior wall of the chamber when the movable member completely opens the outlet. The covering member may rotate about an axis. The outlet may have a length greater than its width, such that the length is generally parallel with the axis of rotation. The outlet may generally form an ellipse. The doser may be integrally coupled with the container.

The apparatus also may include granulated material within the container. Exemplary granulated materials include laxative powder, beverage powder such as for sports drinks or diet drinks, gunpowder, and any other granulated material which can advantageously be dispensed from a container in a metered dose.

In some embodiments, the covering member may have an outer member periphery greater than its inlet periphery. In another embodiment, the inlet may have a first dimension along the direction of rotation, and the outlet may have a second dimension along the direction of rotation, such that the covering member is rotatable a distance about equal to the sum of the first dimension and second dimension to fully open the outlet from a position in which the inlet is fully opened. In certain embodiments the distance of rotation may not exceed 170 degrees.

In accordance with another embodiment of the invention, a method of dispensing material provides a dispensing apparatus having a container containing granulated material to be dispensed, and a doser coupled with the container. The doser includes a housing forming a chamber with an interior wall, an inlet, and an outlet. The doser also includes a covering member that is rotatable within the housing about an axis. The method rotates the covering member to cover the outlet and fully open the inlet. The method further orients the dispensing apparatus so that the granulated material within the container enters the doser chamber through the inlet. The interior wall of the chamber retains, at least in part, the granulated material within the doser when the inlet is fully open, and the granulated material enters the doser. The method permits the granulated material to exit the doser by rotating the covering member to cover the inlet and fully open the outlet. The interior wall of the housing retains, at least in part, the granulated material within the doser when the outlet is fully opened and the granulated material exits the doser.

### BRIEF DESCRIPTION OF THE DRAWINGS

Those skilled in the art should more fully appreciate advantages of various embodiments of the invention from the following “Description of Illustrative Embodiments,” discussed with reference to the drawings summarized immediately below.

FIG. 1 schematically shows a prior art dispenser and problems associated with its use.

FIG. 2 schematically shows a dispenser configured in accordance with illustrative embodiments of the invention, and its use.

FIG. 3 schematically shows an exploded view of the dispenser shown in FIG. 1.

FIG. 4 schematically shows a cross-sectional view of a doser and its three stages of operation.

FIG. 5 schematically shows a cross-sectional view of an entire dispenser configured in accordance with illustrative embodiments of the invention.

FIG. 6 schematically shows a rear, perspective view of a dispenser configured in accordance with illustrative embodiments of the invention.

FIGS. 7 and 8 schematically show a dispenser implementing illustrative embodiments of the invention and two different examples of corresponding handle locking mechanisms.

FIG. 9 is one process of using the illustrative dispenser in accordance with various embodiments of the invention.

### DESCRIPTION OF ILLUSTRATIVE EMBODIMENTS

In illustrative embodiments, a dispenser has a doser that more easily and efficiently dispenses a metered dose of granular material. In fact, various embodiments of the doser dispense this metered dose 1) without exposing the interior of the container to the external environment and 2) while reducing the likelihood of spillage. The apparatus thus overcomes shortcomings of prior art dispensers known to the inventors, which undesirably are prone to spillage and clumping due to exposure to the external environment. Illustrative embodiments provide these benefits in a more manufacturable, lighter weight, and easier to use device. Additional details are discussed below.

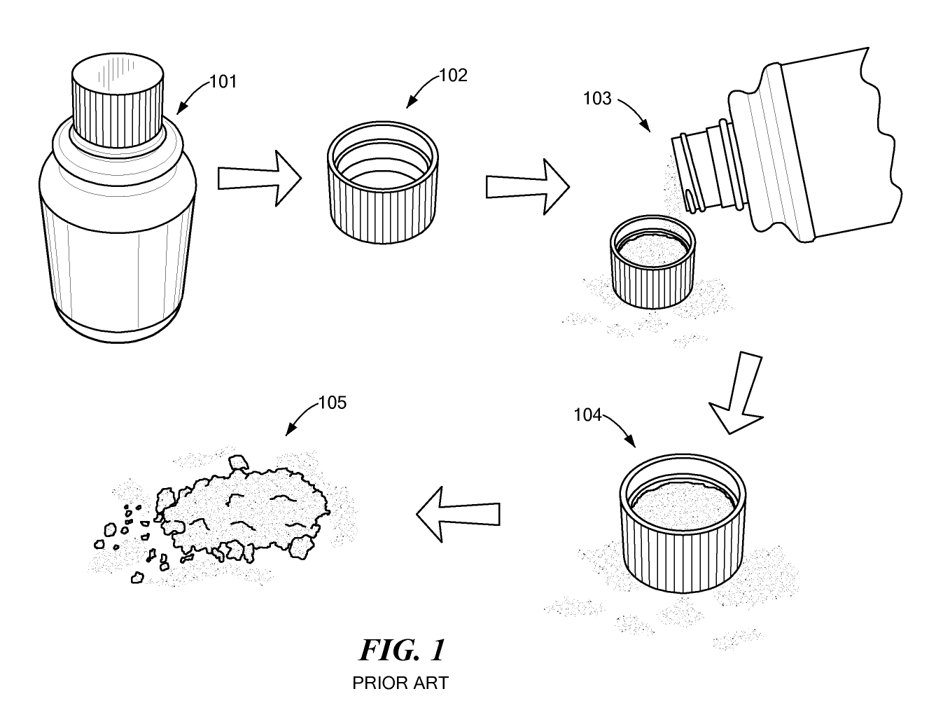

FIG. 1 schematically shows a prior art dispenser containing granular material. As shown in view 101, the dispenser has a standard child resistant cap secured to a blow molded bottle. The child resistant cap requires a strong push and twist to remove the cap—often requiring too much force for adults, particularly the elderly. After the cap is removed, as shown in view 102, it may be difficult to discern any markings indicating a fill level. Again, this is particularly difficult for the elderly and people with poor vision.

Views 103 and 104 illustrate further potential problems with the prior art dispenser. Specifically, if not precisely poured, the granular material can spill, causing a mess requiring cleaning. View 105 shows yet another problem: as the contents of the dispenser are directly exposed to air and moisture outside of the dispenser (i.e., each time the dispenser is opened to dispense product), the product may clump over time. The inventors recognize these problems and deficiencies with the prior art and, consequently, substantially mitigated them by developing an improved dispensing system.

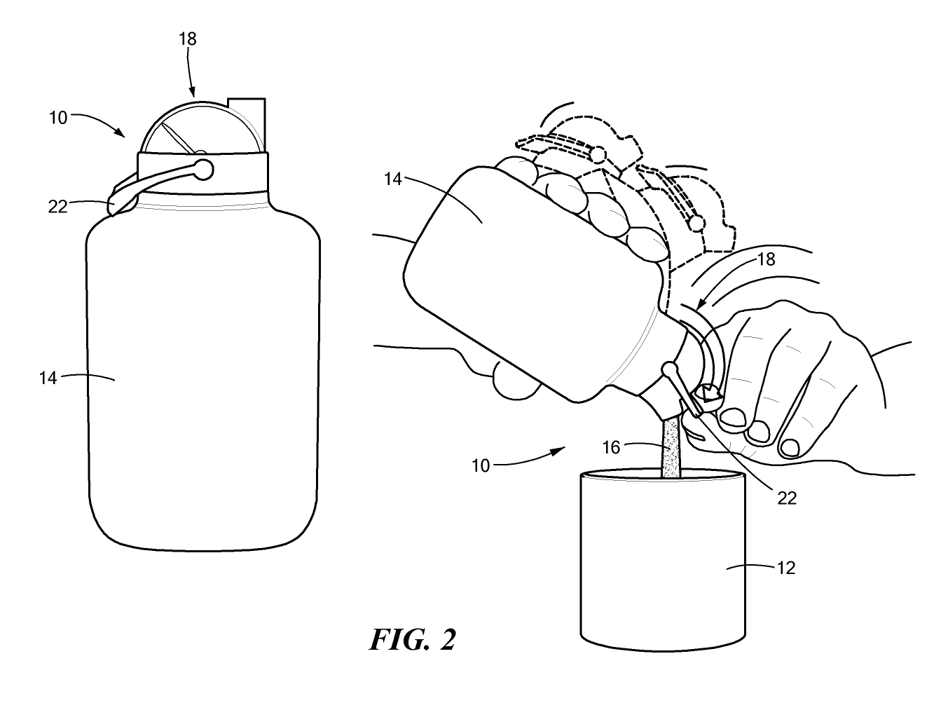

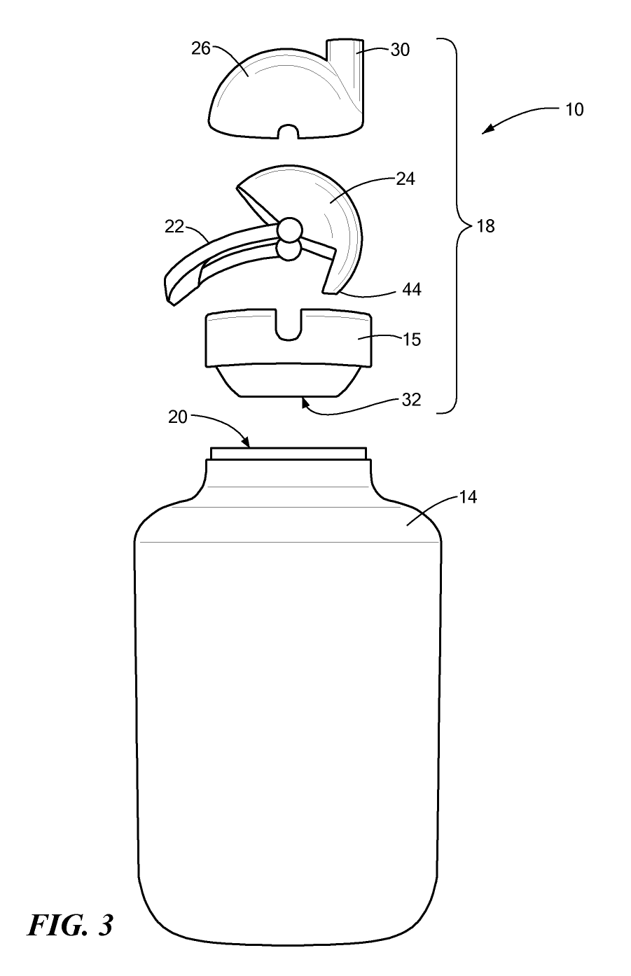

To those ends, FIG. 2 schematically shows a dispenser 10 configured in accordance with an illustrative embodiment of the present invention. Specifically, FIG. 2 shows one view with the dispenser 10 upon a generally flat, level surface (i.e., upright), and another view with a user dispensing a metered dose into a glass 12. To that end, the dispenser 10 has a container 14 holding granular material 16, and a doser 18 secured about an opening 20 (FIG. 3) of the container 14. The container 14 can be any conventional container 14 for holding granulated material 16. For example, the container 14 can be formed from injection molding processes or blow molding processes, among other things. In some embodiments, the container 14 has a neck region with a double helical thread for mating with the doser 18. Alternatively, the container 14 may have no neck and connect to the doser 18 through some other means. Other embodiments integrate the doser 18 into the neck of the container 14 as a single unit.

The granular material 16 may be any commonly dispensed material 16, such as powdered fiber, medicine, spices, gun powder, industrial material, vitamin supplements, or other material. Other embodiments may use the dispenser 10 to dispense material 16 in liquid form.

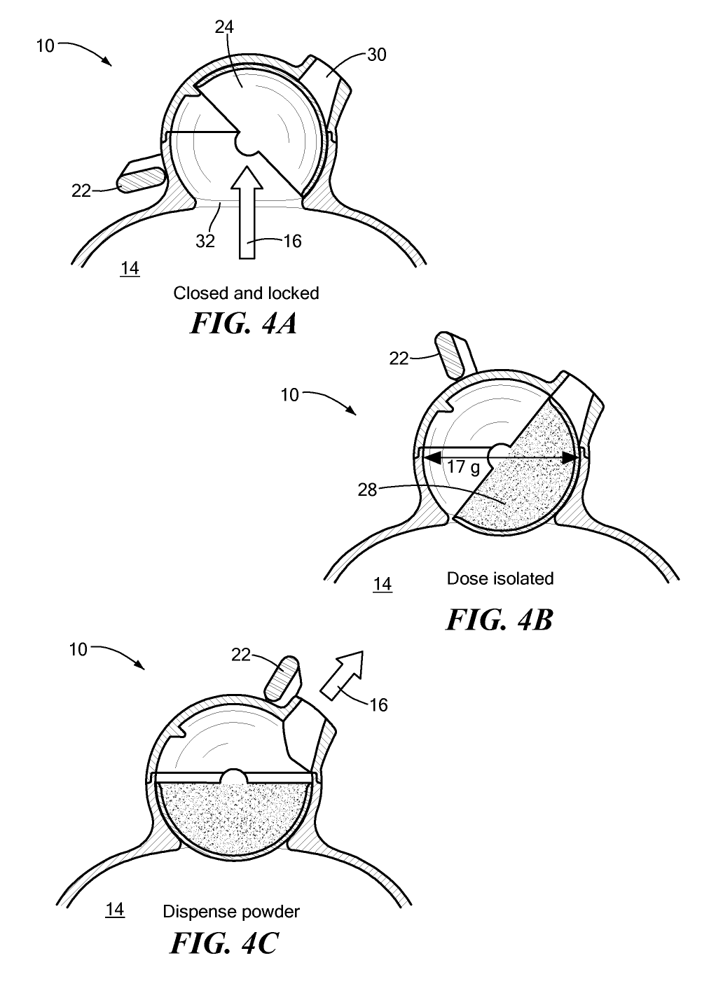

As discussed in greater detail below, the doser 18 has a handle 22 that, in conjunction with an interior covering member 24 (discussed below), rotates a predetermined amount over the exterior doser surface to dispense the material 16 within the container 14. As better shown in the exploded view of FIG. 3, the doser 18 has a housing formed from a partially spherically shaped cap 26 that, together with a connector 15, forms a generally partially spherically shaped interior chamber 28 (FIG. 4) for containing granular material 16 to be dispensed. The cap 26 and connector 15 are configured to form the interior chamber 28 with a specific volume customized for the anticipated use. For example, the volume may be equivalent to two tablespoons of granular material 16.

The doser 18 illustratively is formed from injection molded components. For example, the cap 26 may be formed from clear polypropylene, allowing a user to visually confirm whether the chamber 28 is full of product, empty, or partially filled. A two-shot molding process may be advantageously employed in manufacturing certain embodiments of the present invention. For instance, the rotating lever may formed in the second shot of a two-shot molding process. The use of such techniques (either two-shot molding or standard molding processes) allows for high-volume production of embodiments made from plastic and similarly inexpensive materials, enabling low cost of production.

The interior chamber 28 has two ports—namely, an outlet port 30 or spout 30 for dispensing material 16 from the interior chamber 28, and an inlet port 32 for receiving material 16 from the interior of the container 14. The covering member 24, nested within the cap 26 and coupled with the handle 22, alternatively opens and closes these two ports. Details of that relationship are discussed below.

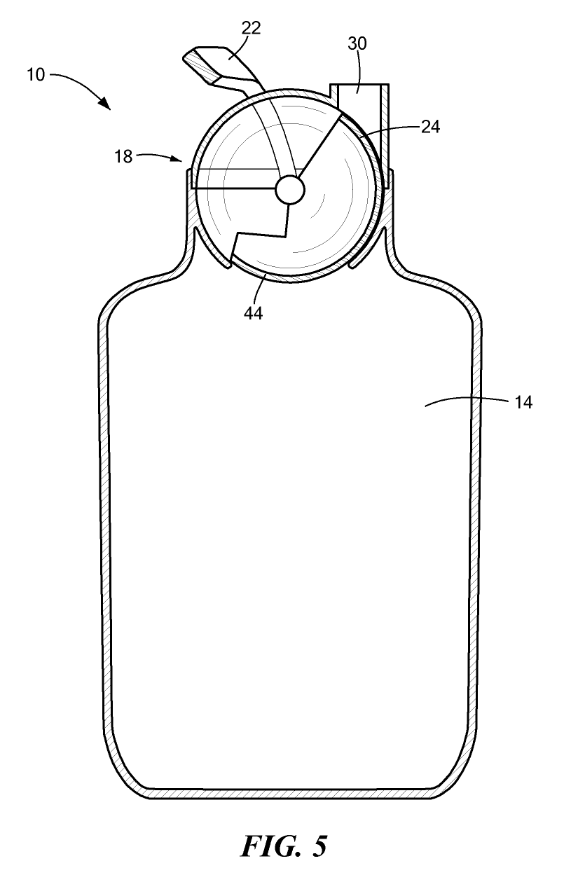

FIGS. 2 and 3 clearly show the output port, while FIGS. 4 and 5 (discussed in greater detail below) show the inlet port 32. The ports preferably are optimized to dispense the granulated material 16 in the most efficient manner while ensuring the integrity of the material 16 remaining in the interior of the container 14. For example, the inlet port 32 may be formed by the connector 15 and have a generally circular to enable a maximum flow of granular material 16 into the interior chamber 28 of the doser 18. The shape and size of the ports thus preferably are optimized as a function of the material 16 they are intended to dispense.

The outlet port 30 also can be shaped in a manner to maximize flow. The inventors discovered, however, that forming the outlet port 30 in an elliptical shape can improve results. Specifically, illustrative embodiments form an elliptical outlet port 30 with a minor axis generally parallel to the direction of movement of the handle 22. This design produces a wide opening, increasing flow from the doser 18. As an example, the outlet port 30 may have a major axis that is about two to three times larger than its minor axis.

The inventors also recognized that the relative positions of the inlet and outlet ports 32 and 30 can have a significant impact on performance and usability. Specifically, the inventors believe that average consumers prefer to rotate the handle 22 as little as possible during the dispensing steps. This conflicts with the goal of ensuring that the material 16 within the container 14 is closed from the environment at all times. Various embodiments reconcile these competing goals.

Specifically, illustrative embodiments do not align the inlet and outlet ports 32 and 30 along a single axis. Instead, such embodiments diametrically offset the inlet and outlet ports 32 and 30. More specifically, the doser 18 may be considered to have a general longitudinal axis, explicitly shown in FIG. 3. This longitudinal axis coincides with the longitudinal axis of the container 14 and extends through both the general center of the doser 18, and the center of the circular inlet port 32. The center of the elliptical outlet port 30, however, is not along this axis. Instead, the center of the elliptical outlet port 30 is radially spaced away from the longitudinal axis. Stated differently, using the frame of reference of the partially spherically shape of the cap 26, the outlet port 30 is spaced more than 180 degrees from the inlet port 32.

In fact, some embodiments form the outlet port 30 as a tubular, elliptically shaped channel extending outwardly and/or upwardly from the cap 26. For example, FIG. 3 shows this channel as extending in a direction generally parallel to the longitudinal axis. Alternatively, FIG. 4 shows this channel extending from the cap 26 at an angle to the longitudinal axis.

The inlet and outlet ports 32 and 30 also may or may not overlap. Specifically, if they do not overlap, then the projection of the outlet port 30 onto the plane of the inlet port 32 in the direction of the longitudinal axis would produce an ellipse that does not overlap with the round inlet port 32—no part of the ports 30 or 32 is diametrically aligned. This projection is referred to herein as the “ellipse projection.” Such embodiments may space this ellipse projection so that it is substantially tangent to, but not extending into, the boundary of the inlet port 32. As shown below, this reduces the stroke to open and close the dispenser 10. It also makes it more convenient to pour the material 16 into a cup or other container 14.

Some embodiments space the ellipse projection from the inlet port 32, thus increasing the stroke to open and close the dispenser 10. In either case, this permits the handle 22 to rotate a greater distance before encountering the outlet port 30, as compared to a configuration that is not offset.

Spacing the ports in this manner also enables the dispenser 10 to have three stages of operation:
An inlet open stage in which the inlet port 32 is open but the outlet port 30 is covered,
An outlet open stage in which the outlet port 30 is open but the inlet port 32 is covered, and
A fully closed stage in which both the inlet and outlet ports 32 and 30 are covered.

FIG. 4 shows these three stages more clearly. Specifically, drawing A of FIG. 4 shows the first stage, in which the covering member 24 closes (also referred to as “covering”) the outlet port 30 while fully opening the inlet port 32. Drawing B of FIG. 4 shows the fully closed stage, in which the covering member 24 closes both ports. Drawing C of FIG. 4 shows the outlet open stage, in which the covering member 24 fully opens the outlet port 30. Thus, those skilled in the art balance the need to have a sufficiently large stroke to maintain the three stages, while minimizing the total stroke length to make it more user friendly.

It should be noted that the term “fully open” is intended to mean that the covering member 24 cannot rotate any farther in the required direction to open the relevant port anymore. For example, in drawing C, the covering member 24 has rotated to its farthest point. In some embodiments, this means that no part of the covering member 24 blocks the interior opening to the outlet channel of the outlet port 30. The covering member 24 therefore either covers the inlet port 32, or is adjacent to an interior wall of the cap housing. In other embodiments, however, the covering member 24 has fully rotated and the outlet port 30 is fully open even though a portion of the covering member 24 may block or partially cover the interior opening to the channel of the outlet port 30. The term “fully open” also has the same meaning when applied to the inlet port 32.

As noted above, some embodiments position the inlet and outlet ports 32 and 30 so that the elliptical projection intersects the inlet port 32. Moreover, it also should be noted that identifying the elliptical projection using the term “elliptical” does not imply that the projection always is elliptical. For example, embodiments using a round outlet port 30 will have a round projection. Accordingly, discussion of an elliptical port is for example only and not intended to limit all embodiments of the invention. In a similar manner, the inlet port 32 can be another shape other than round.

Illustrative embodiments secure the covering member 24 within the cap 26 to seal the ports in a manner that is sufficient for the given application. The cap 26 should provide a sufficient seal or closure for many anticipated uses. For example, the covering member 24 may simply provide a light sliding seal to the ports when dispensing material 16 that is not highly sensitive to the external environment. Alternatively, the covering member 24 may cooperate with the interior surface of the cap 26 to provide a tighter seal. For example, the interior surface of the cap 26 may have an elastomeric material formed around each port. This elastomeric material may provide a tight interference fit for sealing the interior of the doser 18 and container 14. As noted above, those skilled in the art can adjust the effectiveness of the seal based upon the application and use of the dispenser 10. Accordingly, closing one of the ports does not necessarily require a tight, almost hermetic seal. Some embodiments nevertheless may provide such a seal.

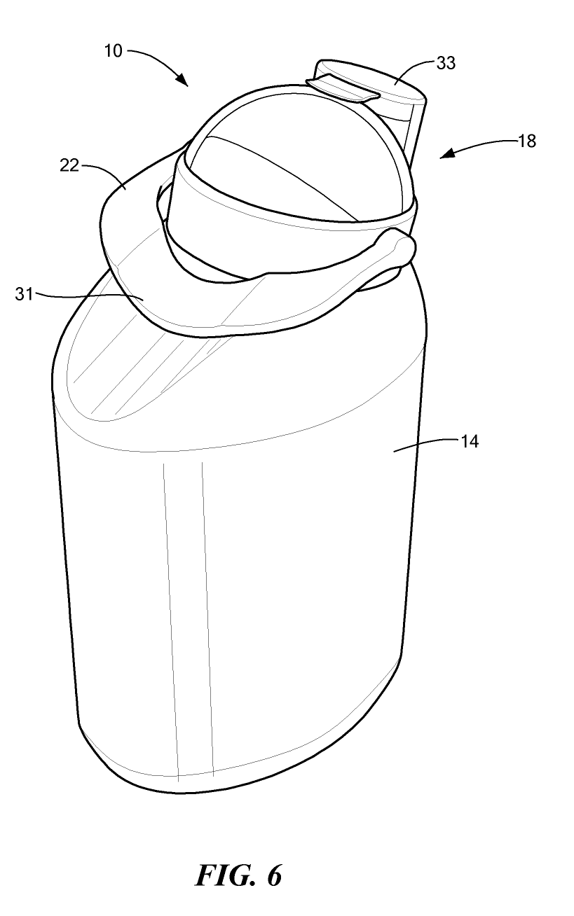

FIG. 5 schematically shows the a cutaway, cross-sectional view of the dispenser 10 in accordance with illustrative embodiments of the invention, while FIG. 6 schematically shows the dispenser 10 from another angle. As shown, the handle 22 illustratively has a generally U-shaped body with a free end rotatably secured to each side of the covering member 24, through the cap 26. The handle body thus rotates along the outer surface of the cap 26 about an axis that is substantially perpendicular to the longitudinal axis noted above. Of course, since it is integral with the handle 22, the covering member 24 also rotates a distance within the cap 26 corresponding to the handle rotation.

The handle 22 preferably does not impede the free flow of material 16 from the outlet port 30. To that end, in preferred embodiments, when the dispenser 10 is oriented upright on a flat surface as shown in FIG. 5, the handle body rotates toward but cannot cover any part of the outlet port 30. In other words, when the dispenser 10 is upright, the handle 22 does not extend above any portion of the spout (in a manner that can impede flow). Accordingly, when pouring in the orientation shown in FIG. 2, the granular material 16 may freely flow without contacting the handle 22. To permit additional rotation, however, the handle body may have a recessed portion 31, generally shaped in a manner that corresponds with the shape of the outlet port 30. Specifically, as best shown in FIG. 6, this recessed portion 31 of the handle 22 permits certain portions of the handle 22 to rotate farther and into the general area of the outlet port 30 without interfering with flowing material 16.

Some embodiments cover the outlet channel from the outside to keep it free of foreign material. Specifically, FIG. 6 schematically shows a lid 33 secured to the outside of the outlet port 30. Any of a number of different designs should suffice. For example, the lid 33 can be completely removable from the outlet port 30, such as with a snap fit or press fit. Alternatively, the lid 33 can have a living hinge that opens and closes the channel with or without user interaction.

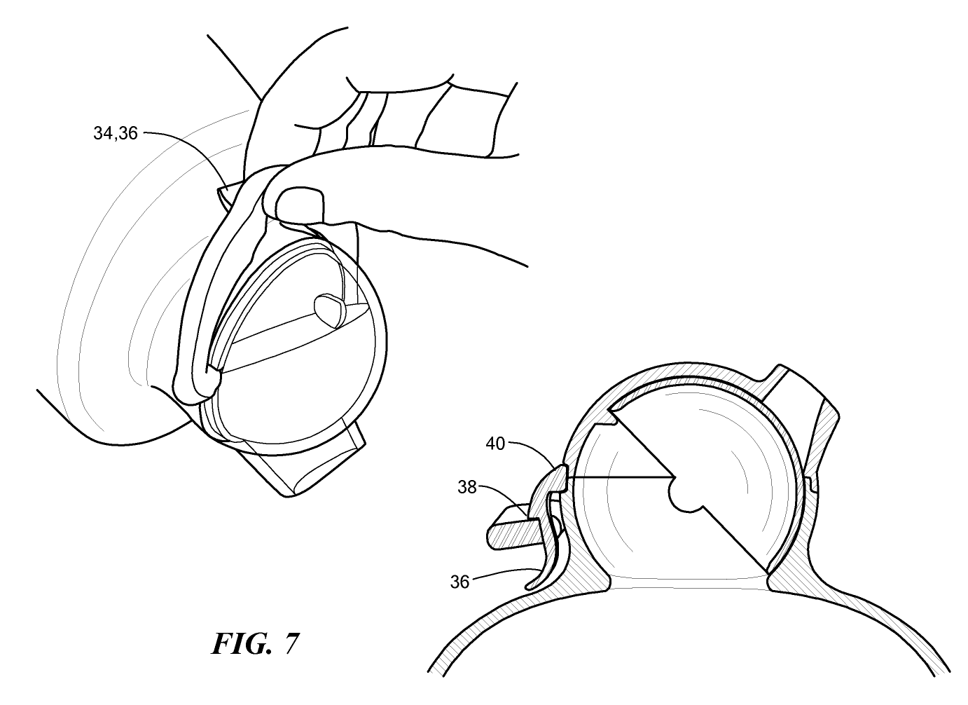

Some embodiments include a mechanism 34 (FIG. 7) for locking the handle 22 in one or more positions. For example, the dispenser 10 may have a mechanism 34 for locking the handle 22 in a closed position to prevent children from dispensing the granular material 16 within the container 14. FIG. 7 shows one such design, in which a leaf spring 36 interacts with the handle 22 to lock it in the closed position. Specifically, the spring 36, which is secured to the outside surface or neck of the doser 18, has an upper lip 38 that mates with the top facing surface of the handle 22. Application of a radially inward force uncouples the handle 22 from the leaf spring 36, thus permitting the handle 22 to rotate toward the open position.

In a corresponding manner, the leaf spring 36 preferably facilitates re-locking by having an angled or camming surface 40. Specifically, on the return stroke, the handle 22 contacts this surface 40 to move the leaf spring 36 radially inwardly. This continues until the handle 22 passes the upper lip 38, which snaps into mating, locking contact with the handle 22.

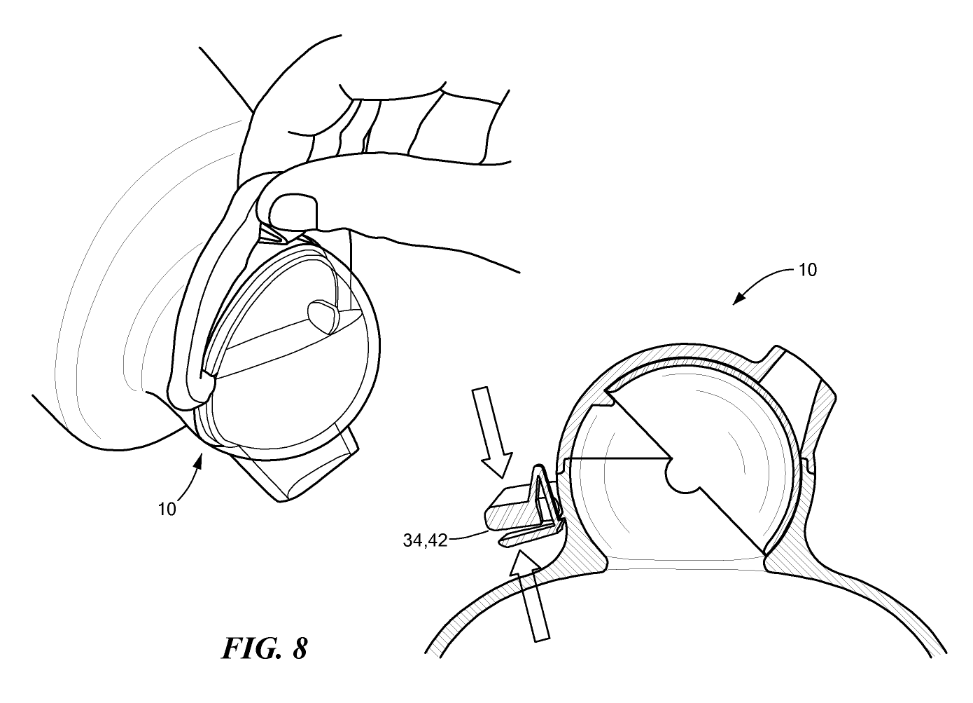

Of course, there are a number of additional embodiments for locking the handle 22. FIG. 8 schematically shows another such embodiment, in which a squeeze tab 42 is integrated into the handle 22 to some extent. Another example may lock the handle 22 on the side surface near where it intersects the cap 26. Moreover, discussion of locking the dispenser 10 in a closed position is just one embodiment. Other embodiments may lock the doser 18 in an open position, or in a position where both of the inlet and outlet ports 32 and 30 are covered. Some embodiments, however, have no locking mechanism 34.

As noted above, various embodiments minimize the distance that the covering member 24 and handle 22 travel to move from fully opening the inlet port 32 to fully opening the outlet port 30. In illustrative embodiments, the handle 22 and covering member 24 move a distance that is substantially equal to the sum of the dimensions of the two ports along the direction of travel. In this case, with ports shaped as shown and discussed above, the handle 22 and covering member 24 move a distance that is approximately equal to the sum of the diameter of the inlet port 32 and the minor axis of the outlet port 30. This ensures that the doser 18 has the above noted three dispensing stages. In one embodiment, the covering member 24 does not rotate more than 170 degrees. In other embodiments, the covering member 24 may rotate less, not exceeding 140 degrees, and even smaller degrees of rotation, such as about 90 degrees. Of course, other embodiments may travel a greater distance or a smaller distance to complete the full stroke of the handle 22 (i.e., between fully opening one port to fully opening the other port).

The covering member 24 therefore may have an irregular shape to accomplish its function. Specifically, as shown in FIG. 3, the covering member 24 may have a generally partial spherical shape, but with an irregular outer periphery. As shown, the covering member 24 may be considered to have a main portion and an extending tongue 44. The tongue 44 is specially shaped and sized to cover the relevant port at the appropriate times. Those skilled in the art can configure the dimensions to appropriately time the stroke to cover the ports.

The covering member 24 thus may cover only a portion of the interior wall of the chamber 28. This may be the case when the outlet port 30 is completely/fully open or when the inlet port 32 is completely/fully open. In some embodiments, the covering member 24 covers only a portion of the interior wall of the chamber 28 at any possible orientation of the covering member 24. Use of a covering member 24 that does not cover the entire interior wall reduces friction between the covering member 24 and the interior wall of the chamber 28, thus making it easier for a user to move the handle 22. This also enables the covering member 24 to be manufactured with less material, making it less expensive and lighter weight. The lighter weight of such a covering member 24 also improves ease of use when compared to that of a heavier member.

Accordingly, material 16 in the chamber 28 directly contacts the interior chamber wall. This may be the case when the outlet port 30 is completely open or when the inlet port 32 is completely open. In some embodiments, the material 16 within the chamber 28 contacts the interior wall of the chamber 28 directly at any possible orientation of the covering member 24.

The covering member 24 also may be described according to an outer member periphery defined by the length around the rim of the covering member 24. In a corresponding manner, each of the outlet and inlet ports 30 and 32 also may have an associated length/periphery defined by their circumferences. According to one embodiment, the outer member periphery of the covering member 24 may be greater than the inlet port periphery. The outer member periphery also may be greater than the outlet periphery. Such configurations may describe results analogous to configurations described above, according to which the material 16 contacts the chamber wall or only a portion of the interior wall is covered by the covering member 24 at particular orientations of the covering member 24.

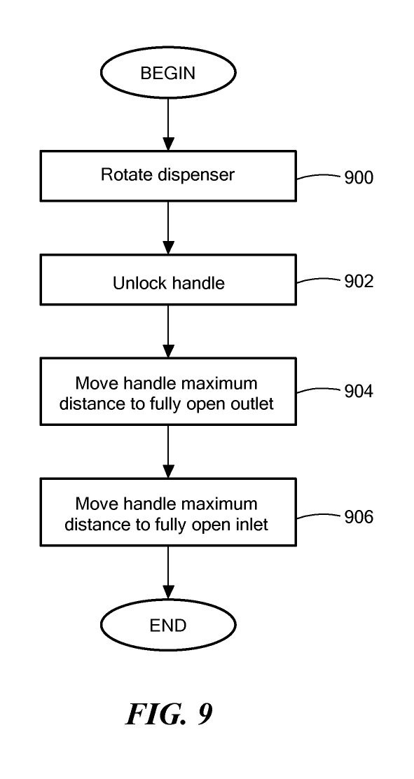

FIG. 9 teaches a process of using the dispenser 10 in accordance with illustrative embodiments of the invention. The process begins at step 900, in which a user rotates the dispenser 10 to at least partially fill the cap 26 with granular material 16. FIG. 2 shows this step in greater detail in which a user grasps the dispenser 10 as it stands upright in view A of FIG. 2, and rotates it clockwise as shown in view B of FIG. 2. As shown, the dispenser 10 still works sufficiently well despite the fact that the user does not rotate it 180 degrees from its position in view A. The amount of rotation required depends upon a number of factors. For example, the user may not choose to use a full dose. Indicia on the outside of the cap 26 also can guide the user as to how much material 16 to dispense and thus, how much to rotate the dispenser 10. Another factor may include the type of granular material 16 within the container 14.

Next, the user releases the locking mechanism 34 on the handle 22, such as the leaf spring 36 (step 902), and then rotates or moves the handle 22 the maximum distance allowed to fully open the outlet port 30 (step 904). Again, as noted above, illustrative embodiments time the stroke of the handle 22 to ensure that the material 16 is not exposed to the external environment at any point. In other words, either the outlet port 30 is closed, the inlet port 32 is closed, or both ports are closed. Those embodiments prevent both ports from being open at the same time.

Stops (not shown) within the interior of the chamber 28 or exterior to the cap 26 may limit the stroke of the handle 22 in both directions. As discussed above, FIG. 4 schematically shows this step as it moves between the 3 stages—from closed to dispensing. Thus, unlike a number of prior art devices known to inventors, rather than moving the granular material 16 toward the outlet port 30, the covering member 24 moves/cuts through the granular material 16 to open and close the ports in the noted manner. Moreover, since the covering member 24 has a smaller surface area than that of the interior of the chamber 28, it should encounter less frictional resistance as it moves, and have less potential to move the material 16 in a wholesale/bulk manner from the inlet port 32 to the outlet port 30.

After dispensing the material 16, the user moves the handle 22 back to its original position to fully open the inlet port 32 (step 906). To that end, the user rotates the handle 22 the maximum distance back toward its original position until the locking mechanism 34 locks it in place. As noted above, if the dispenser 10 has no locking mechanism 34, then the handle 22 simply is moved/rotated its maximum distance to fully open the inlet port 32. As noted, this rotation preferably is less than about 180 degrees (e.g., about 120 degrees, about 130 degrees, or about 140 degrees).

Accordingly, illustrative embodiments permit a user to more easily dispense granular material 16, thus mitigating the likelihood of spillage and messy cleanups. Moreover, embodiments that permit no more than one port to be open at any given time further protect the granular material 16 from environmental contaminants, such as moisture. The reduced surface area of the covering member 24 and offset positioning of the ports favorably reduces the length of the handle stroke and frictional resistance.

Although the above discussion discloses various exemplary embodiments of the invention, it should be apparent that those skilled in the art can make various modifications that will achieve some of the advantages of the invention without departing from the true scope of the invention.

What is claimed is:

1. A dispensing apparatus comprising:
a container having an opening; and
a doser coupled with the container about the container opening,
the doser comprising a housing forming a chamber with an interior wall, an inlet, and an outlet, wherein the inlet and outlet are diametrically offset,
the inlet being substantially aligned with the opening of the container,
the doser also having a covering member to alternatively cover and open the inlet and the outlet, the covering member being movable about a range of positions to substantially completely cover at least one of the inlet and outlet at all positions in the range, the covering member covering no more than a portion of the chamber interior wall when the covering member completely opens the outlet.

2. The dispensing apparatus as defined by claim 1 wherein the covering member covers no more than a portion of the chamber interior wall when the inlet is completely open.

3. The dispensing apparatus as defined by claim 1 wherein no part of the inlet is diametrically aligned to any part of the outlet.

4. The dispensing apparatus as defined by claim 1 wherein the covering member rotates about an axis having two ends, the doser further comprising a handle coupled to both ends of the axis.

5. The dispensing apparatus as defined by claim 4 wherein the handle is rotatable about the axis, the outlet forming a spout having an outer periphery, the handle being configured to rotate no farther than any portion of the outer periphery of the spout.

6. The dispensing apparatus as defined by claim 4 wherein the handle is rotatable about the axis, the outlet forming a spout, the handle being configured not to rotate to a position that extends above any portion of the spout.

7. The dispensing apparatus as defined by claim 4 further comprising a stop removably coupled with the handle, the stop preventing rotation of the handle when coupled with the handle.

8. The dispensing apparatus as defined by claim 1 wherein the covering member rotates about an axis, further wherein the outlet has a length and a width, the length being generally parallel with the axis, the length being greater than the width.

9. The dispensing apparatus as defined by claim 1 wherein the outlet generally forms an ellipse.

10. The dispensing apparatus as defined by claim 1 wherein the doser is integrally coupled with the container.

11. The dispensing apparatus as defined by claim 1 further comprising granular material within the container.

12. The dispensing apparatus as defined by claim 1 wherein the range of positions of the covering member substantially prevents communication between the interior of the container and the exterior of the dispensing apparatus.

13. The dispensing apparatus as defined by claim 1 wherein the covering member is a single integral member.

14. A dispensing apparatus according to claim 1, wherein the covering member is configured to permit material to directly contact the interior wall of the chamber when the movable member completely opens the outlet.

15. A dispensing apparatus comprising:
a container having an opening; and
a doser coupled with the container about the container opening,
the doser comprising a housing forming a chamber with an interior wall, an inlet with an inlet periphery, and an outlet with an outlet periphery, wherein the inlet and outlet are diametrically offset,
the inlet being substantially aligned with the opening of the container, the doser also having a covering member to alternatively cover and open the inlet and the outlet, the covering member being movable about a range of positions to substantially completely cover at least one of the inlet and outlet at all positions in the range,
the covering member having an outer member periphery, the outer member periphery being greater than the inlet periphery.

16. The dispensing apparatus as defined by claim 15 wherein the outer member periphery is greater than the outlet periphery.

17. The dispensing apparatus as defined by claim 15 wherein no part of the inlet is diametrically aligned to any part of the outlet.

18. The dispensing apparatus as defined by claim 15 wherein the covering member rotates about an axis having two ends, the doser further comprising a handle coupled to both ends of the axis.

19. The dispensing apparatus as defined by claim 18 wherein the handle is rotatable about the axis, the outlet forming a spout, the handle being configured not to rotate to a position that extends above any portion of the spout.

20. The dispensing apparatus as defined by claim 15 wherein the covering member rotates about an axis, further wherein the outlet has a length and a width, the length being generally parallel with the axis, the length being greater than the width.

21. The dispensing apparatus as defined by claim 15 wherein the outlet generally forms an ellipse.

22. The dispensing apparatus as defined by claim 15 further comprising granulated material within the container.

23. The dispensing apparatus as defined by claim 15 wherein the range of positions of the covering member substantially prevents communication between the interior of the container and the exterior of the dispensing apparatus.

24. The dispensing apparatus as defined by claim 15 wherein the covering member is a single integral member.

25. A dispensing apparatus comprising:
a container having an opening; and
a doser coupled with the container about the container opening,
the doser comprising a housing forming a chamber with an interior wall, an inlet, and an outlet, wherein the inlet and outlet are diametrically offset,
the inlet being substantially aligned with the opening of the container,
the doser also having a covering member that rotates about an axis to alternatively cover and open the inlet and the outlet, the inlet having a first dimension along the direction of rotation, the outlet having a second dimension along the direction of rotation, the covering member being rotatable a distance about equal to the sum of the first dimension and second dimension to fully open the outlet from a position in which the inlet is fully opened, the distance of rotation not exceeding 170 degrees.

26. The dispensing apparatus as defined by claim 25 wherein the covering member rotates about an axis having two ends, the doser further comprising a handle coupled to both ends of the axis.

27. The dispensing apparatus as defined by claim 26 wherein the handle is rotatable about the axis, the outlet forming a spout having an outer periphery, the handle being configured to rotate no farther than any portion of the outer periphery of the spout.

28. The dispensing apparatus as defined by claim 26 wherein the handle is rotatable about the axis, the outlet forming a spout, the handle being configured not to rotate to a position that extends above any portion of the spout.

29. The dispensing apparatus as defined by claim 25 wherein the covering member has a member perimeter and the inlet has an inlet perimeter, the member perimeter being greater than the inlet perimeter.

30. The dispensing apparatus as defined by claim 25 wherein the covering member has a member perimeter and the outlet has an outlet perimeter, the member perimeter being greater than the outlet perimeter.

31. The dispensing apparatus as defined by claim 25 wherein the covering member is formed from a moldable material.

32. A method of dispensing material, the method comprising:
providing a dispensing apparatus having a container containing granulated material to be dispensed, and a doser coupled with the container, the doser comprising a housing forming a chamber with an interior wall, an inlet, and an outlet, the doser also having a covering member that is rotatable within the housing about an axis;
rotating the covering member to cover the outlet and fully open the inlet;
orienting the dispensing apparatus so that the granulated material within the container enters the doser chamber through the inlet, the interior wall of the chamber at least in part retaining the granulated material within the doser when the inlet is fully open and the granulated material enters the doser; and
permitting the granulated material to exit the doser by rotating the covering member to cover the inlet and fully open the outlet, the interior wall of the housing at least in part retaining the granulated material within the doser when the outlet is fully opened and the granulated material exits the doser.

33. The method of claim 32, wherein the inlet and outlet are diametrically offset.

34. The method of claim 32 wherein the covering member covers no more than a portion of the chamber interior wall when the inlet is completely open.

35. The method of claim 32 wherein the covering member rotates about an axis through the range, the rotation being no greater than about 140 degrees.

36. The method of claim 32 wherein the covering member has a member perimeter and the inlet has an inlet perimeter, the member perimeter being greater than the inlet perimeter.

37. The method of claim 32, wherein the covering member is configured to permit material to directly contact the interior wall of the chamber when the movable member completely opens the outlet.

38. A doser system for coupling with a container, the doser comprising:
a housing forming a chamber with an interior wall, an inlet, and an outlet, wherein the inlet and outlet are diametrically offset,
the doser also having a covering member to alternatively cover and open the inlet and the outlet, the covering member being movable about a range of positions to substantially completely cover at least one of the inlet and outlet at all positions in the range, the covering member covering no more than a portion of the chamber interior wall when the covering member completely opens the outlet.

39. The doser system as defined by claim 38 further comprising a container secured to the housing.
